(19) United States
(12) Patent Application Publication
(10) Pub. No.: US 2003/0132944 A1
(43) Pub. Date: Jul. 17, 2003

(54) User control of generalized semantic zooming

(75) Inventor: Randall B. Smith, Palo Alto, CA (US)

Correspondence Address: Jeffrey C. Hood, Conley, Rose, & Tayon, P.C., P.O. Box 398, Austin, TX, 78767, US

(73) Assignee: Sun Microsystems, Inc.

(21) Appl. No.: 10/156,169

(22) Filed: May 28, 2002

Related U.S. Application Data
(63) Continuation-in-part of application No. 09/970,082, filed on Oct. 3, 2001.

(51) Int. Cl. G09G 5/00

(52) U.S. Cl. 345/581

(57) ABSTRACT

A system and method for controlling the presentation of information on a display device concerning a collection of objects. A processor receives user inputs defining one or more user-adjustable filters. For each object in the collection, the processor computes an information control value using the one or more filters. Each filter operates on one or more data fields on the objects. The information control value then determines how much information is to be displayed for the object. Furthermore, the user may dynamically adjust parameters of the filters. Thus, the user may control which populations of objects are displayed with a rich set of information and which populations are displayed sparsely.

### CONTINUATION DATA

This application is a continuation-in-part of U.S. patent application Ser. No. 09/970,082, filed on Oct. 3, 2001, entitled “Stationary Semantic Zooming”, invented by Randall B. Smith.

### BACKGROUND

1. Field of the Invention

This invention relates generally to the field of computer graphics and, more particularly, to man-machine interface software applications.

2. Description of the Related Art

Computer-based systems may store records of information concerning objects (real-world objects and/or virtual objects). A user desiring to observe or analyze the objects may be faced with the problem of volume. There may be a large number of records, with each record containing a non-trivial amount of data. Thus, the naïve strategy of outputting to the user all the information in each data record would overwhelm the user's capacity to meaningfully absorb information. Therefore, there exists a need for systems and methods for searching and filtering the set of data records, or more generally, for controlling the output of object information to the user.

Crowded displays arise in many applications. It can be visually distracting and computationally inefficient to render all the available information on the screen. Quite often the user is interested in certain subsets of the available information. Thus, there exists a need for the system and method capable of filtering information in accord with the user preferences.

### SUMMARY

In one set of embodiments, a computer system may be configured to dynamically control the visual display of information presented on a display device based on one or more user-adjustable filters (also referred to herein as evaluation criteria or evaluation functions). The computer system may include a processor, a memory, a display device, and one or more input devices. The memory may store data records associated with a collection of objects. The data records may describe any of a variety of real world objects and/or virtual objects. Each data record may correspond to one of the objects, and include a plurality of data fields associated with the corresponding object.

The processor may receive user input through the one or more input devices specifying parameters for the one or more filters. For example, the user may specify the filter parameters by clicking buttons, entering values in numeric input fields, manipulating sliders, dials and scroll bars, checking/unchecking option flags and so forth through a graphical user interface (or a physical hardware interface) managed by the processor. Each filter may operate on one or more data fields of the object data records. Each filter may return a numeric value, e.g., a positive number in the range from zero to one inclusive.

The filter parameters control the filtering operation to be performed by the filters. For example, a bandpass filter for a certain data field may be controlled by a band center and a bandwidth parameter. A lowpass filter for another data field may be controlled by a single cutoff value.

The processor may apply the filters to each data record (in the collection of data records) to determine a corresponding information control value. The information control value indicates an extent to which the data record (or the corresponding object) satisfies one or more user-adjustable criteria as represented by the filters. For example, the processor may apply the one or more filters to the data fields of each data record. The resultant values from the one or more filters may be combined (i.e. mixed) in a linear or nonlinear fashion to determine the information control value. The user may specify and dynamically adjust the coefficients of the mixing process.

The processor may display a visual representation of the collection of objects (or the collection of data records) on the display device, where the amount of information displayed for each object in the visual representation depends on the information control value of the corresponding data record.

The filters have parameters such as bandwidths, band center values, cutoff values, etc. The processor may repeatedly:

(a) receive user updates of the filter parameters from the input devices,

(b) recalculate the information control values for the objects in the object collection, and

(c) update the visual representation of the objects based on the recalculated information control values.

Thus, the user may dynamically adjust the filter parameters and observe the evolution of object populations either coming into information prominence or fading into relative information obscurity. This mechanism may allow the user to search the space of objects in a controlled manner. It also saves computational bandwidth because the processor (and/or other associated rendering hardware) is not called upon to render a visual representation of all the objects with full detail. The filters cut down the total amount of information rendered onscreen, and thus, the amount of rendering effort.

The information displayed for an object (or data record) may be symbolic information, textual information, numeric information, or any combination thereof. Furthermore, information may be conveyed through any of various means such as texture, color, opacity-transparency, material luminosity, blinking (and rate of blinking), reflectivity, size, shape, sound, movement and so on. For example, if object A has a larger information control value than object B, object A may be displayed with more symbolic information, more textual information, more numerical information, more opacity (i.e. less translucence), larger size, increased movement (or a different kind of movement), increased sound (or better sound quality), and/or more graphical rendering effort (e.g. higher supersample-to-pixel ratio, higher quality anti-aliasing filters, more primitives) than object B. The amount of information presented for an object may be a monotonic function (e.g. a monotonically increasing function) of its information control value.

A person (e.g. a system designer) may generate M rendering plans for the rendering and display of objects in a visual representation. The rendering plans may be used to render the objects on the display device. The M rendering plans may be configured as an ordered succession from low information content to high information content. The M rendering plans may be mapped to M corresponding states of the information control value.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates one set of embodiments of a computer system configured to control the presentation of information to a user based on one or more user-adjustable filters;

FIG. 2 illustrates one set of embodiments of a method allowing a user to dynamically control the presentation of information on an output device; and

FIG. 3 illustrates another set of embodiments of a method allowing a user to dynamically control the presentation of information on an output device.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

In one set of embodiments, a software application executing on a computer system may be configured to dynamically filter information presented to a user (through a user interface) based on one or more user-adjustable filters.

The software application may generate a visual output (e.g., on a display screen, a projection screen, or a head-mounted display) representing a collection of objects. Each object is represented by (or corresponds to) a data record stored in a memory. The object data record has a number of fields. Thus, the object data record may be interpreted as a point in an N-dimensional data space, where N is a number of fields in the data record. The user may be interested in seeing more information on objects that are near to some particular point in the data space, and less information on objects that are remote from the particular point, or vice versa. Thus, the software application may perform a filtering operation on the object data records based on how close the object data records are to the point of interest in the data space. Furthermore, the user may be interested in moving the point of interest in the N-dimensional data space in order to observe differing populations of the objects come into information prominence. Thus, the software application may implement a processing loop that looks like:

START_LOOP

receive update values for the point-of-interest P_{U};
for each object in the object collection:

(a) compute a distance D_{obj} between the object's data record and
the point P_{U} in the N-dimensional data space;
(b) construct an output packet (e.g. an icon) for the object which
contains an amount of information (or level of detail)
that depends
on the distance D_{obj};
(c) display the output packet (or the information represented
in the
output packet) on a display device;

next object;

GOTO START_LOOP

It is noted that the distance D_{obj} is not necessarily a Euclidean distance. Any of various metrics or vector norms (or approximations thereof) may be used to compute distance D_{obj}.

Also, the user may be interested in specifying a region around the point-of-interest P_{U} (or related to the point-of-interest) in order to see more information on objects inside the region and less information on objects outside the region, or vice versa. Furthermore, the user may be interested in adjusting the region of interest (e.g. the width of the region along one or more data space axes), and observing which objects rise to information prominence and which objects fade into the information background. Thus, the software application may implement the following processing loop:

START_LOOP

receive update values for the point P_{U};
receive update values for size parameters S_{U} of the
region-of-interest R_{U};
for each object in the object collection:

(a) evaluate a function f(X_{obj},P_{U},S_{U}) to determine an
information
control value ICV_{obj} for the object, where X_{obj} is the position
of the
object (or the object's data record) in the N-dimensional data
space, where the function f decreases (or increases) as the vector
variable X_{obj} moves outside the region R_{U} (e.g., the function
f may
transition to zero, or one, as the vector variable X_{obj} moves
outside
the region R_{U});
(b) construct an output packet (e.g. an icon) for the object which
contains an amount of information (or level of detail) that
depends
on the information control value ICV_{obj};
(c) display the output packet (or the information represented
in the
output packet) on a display device;

next object;

GOTO START_LOOP

Thus, the user is able to control how much information is displayed (e.g. by adjusting the size parameters or boundary parameters of the region R_{U}) and which subsets of the objects get displayed richly (by adjusting the point-of-interest P_{U}). As the user moves the point-of-interest P_{U} and the region parameters, he/she may observe differing populations of the objects come into information richness. In some embodiments, the software application iterates the processing loop quickly enough to provide real-time updates of the visual output.

It is noted that the function used in step (a) may be a function (e.g. a multi-dimensional Gaussian) which smoothly transitions from one to zero as a function of displacement away from the point-of-interest. Thus, the amount of information presented in the object packets of objects may vary from maximal richness to a background level depending on displacement from the point-of-interest.

More generally, the software application may implement the following processing loop:

START_LOOP

receive user updates to a vector U of user parameters;
for each object in the object collection:

(a) evaluate (or execute) a function f(X_{obj},U) to determine an
information control value ICV_{obj}, where X_{obj} is the position
of the
object's data record in the N-dimensional space;
(b) construct an output packet (e.g. an icon) for the object which
contains an amount of information (or level of detail) that
depends
on the information control value ICV_{obj};
(c) display the output packet (or the information represented
in the
output packet) on a display device;

next object;

GOTO START_LOOP

Thus, in certain circumstances, the information control value may have a more complex dependence on the data space vector variable X than those described in the previous embodiments.

In one embodiment, the function f(X_{obj},U) represents an arbitrary program that operates on the object's data space vector X_{obj} and the user parameter vector U to compute one or more numeric values. The one or more numeric values determine how the object is displayed on a display surface. The program may implement any desired processing algorithm.

In one set of embodiments, two or more information control values may be computed for an object data record, and the two or more information control values may be used to construct the output packet for the object. In this case, the software application may implement the following processing loop:

START_LOOP

receive user updates to a vector U of user parameters;
for each object in the object collection:

(a) evaluate two or more functions to determine two or more
corresponding information control values, where each function
operates on a subset of the coordinates of the record position
X_{obj}
and uses a subset of the user parameters;
(b) construct an output packet (e.g. an icon) for the object which
contains an amount of information (or level of detail) that
depends
on the two or more information control values;
(c) display the output packet (or the information represented
in the
output packet) on a display device;

next object;

GOTO START_LOOP

Each information control value may control the inclusion (or the extent of inclusion) of a different kind of information in the output packet. In one embodiment, N information control values are used, one information control value for each data field Xᵢ.

In some embodiments, the software application may incrementally build a pixel representation of an object on a display surface based on a series of comparisons between various fields of the object's data vector X and corresponding fields in the user parameter vector U. For example, in one object-oriented implementation, a method display( ) may be defined for a display screen, and another method displayOn( ) may be defined in each object. The method display calls the method displayOn in each object. Recall that an object (such as the display screen object) may pass itself as a parameter to a method by referring to itself as “this” (or “self” in some languages).

The method display in the display screen may be implemented according to the following pseudo-code:

```
display( ){
  Get user inputs U;
  For each object D in object collection
    D.displayOn(this,U);
  }
```

Let X_{D} represent the position of the object D in the N-dimensional data space. The method displayOn may be implemented according to the following pseudo-code:

displayOn(displayScreen S, userParameters U){

partially draw on S according to a first comparison between the
object's data
vector X_{D} and the user parameter vector U;
partially draw more on S according to a second comparison between
the
object's data vector X_{D} and the user parameter vector U;
.
.
.
partially draw more on S according to an L^{th} comparison between the
object's data vector X_{D} and the user parameter vector U;
return;

}

L is an integer greater than or equal to two. In each of the partial drawing steps, the displayOn method may use a corresponding function f_{K}(X_{D},U) to implement the corresponding comparison on the object's data vector X_{D} and the user parameter vector U. Index K ranges from 1 through L. Each function f_{K} influences the drawing in the corresponding partial drawing step. Each function f_{K} may have any of a variety of forms.

In one embodiment, the function f_{K} in each partial drawing step may be an arbitrary program. An arbitrary is more general than any particular mathematical function or finite combination of mathematical functions.

Each function f_{K} may operate on a corresponding set of one or more fields in the object's data vector X_{D} and a corresponding set of fields in the user parameter vector U. In one embodiment, each function f_{K} may operate on a single field X_{D}(K) in the object's data vector X_{D} and a corresponding field U(K) of the user parameter vector U.

In one embodiment, a first function f₁ may operate on a first field of the object's data vector and a first field of the user parameter vector. The output value generated by the first function may be used to select a background for the object to be drawn on the display surface

A second function f₂ may operate on a second field of the object's data vector and a second field of the user parameter vector. The output value generated by the second function may be used to select a border for the object to be drawn on the display surface.

A third function f₃ may operate on a third field of the object's data vector and a third field of the user parameter vector. The output value generated by the third function may be used to control whether a certain label (or indicator) is to be drawn onto the display surface for the object.

A fourth function f₄ may operate on a fourth field of the object's data vector and a fourth field of the user parameter vector. The output value generated by the fourth function may be used to control whether a textual descriptor is to be drawn onto the display surface for the object.

In one set of embodiments, the objects may be nodes (e.g. client and server computers) in a computer network, and the visual output generated by the software application may be a diagram of the computer network. The data record for each node stores information associated with the node such as an IP address, manufacturer, serial number, last maintenance date, amount of RAM, hard drive capacity, indicators of installed software packages, indicators of installed hardware devices, etc. Icons in the diagram correspond to nodes on the computer network.

To define the point-of-interest P_{U} and the related region R_{U}, the software application may receive user inputs specifying a value-of-interest Vᵢ and a bandwidth-of-interest σᵢ along one or more of the data space axes Xᵢ. For example, the user may be interested in seeing more detailed information on nodes in the network that have an install date of plus or minus ΔT₁, years around a date D₁.

The software application may also receive user inputs specifying an interval of interest [Aᵢ,Bᵢ] along one or more of the data space axes Xᵢ. For example, the user may be interested in seeing more detailed information on nodes in the network that have a computational load in the range between C and D.

Furthermore, the software application may also receive inputs specifying an interval of interest having any of the forms Xᵢ<Bᵢ, Xᵢ<=Bᵢ, Xᵢ>Aᵢ, or Xᵢ>=Aᵢ, for one or more of the data space axes Xᵢ. For example, the user may be interested in seeing more detailed information on nodes in the network that have more than S units of RAM, and less than or equal to Y units of free hard drive space. (The symbol “<=” denotes the less than or equal to operator. The symbol “>=” denotes the greater than or equal to operator.)

As described above in general terms, the software application dynamically filters node data records based on the current state (e.g. the instantaneous state) of the user parameters. Thus, the user may adjust the user parameters (i.e. parameters such as D₁, ΔT₁, C, D, S and Y), and observe differing populations of nodes come into information prominence (i.e. richness of iconic information detail).

For each iteration of the processing loop and for each node, the software application may calculate an information control value ICV_{nd} that determines the amount of information to be displayed in/on/near/around/over/under/through . . . the node's icon or by means of the node's icon.

A node having a maximal information control value may be displayed with a richly detailed icon, i.e. an icon including a rich set of information (e.g. most or all of the information available in the corresponding node data record). A node having a minimal information control value may be displayed with a minimally detailed icon, perhaps only a dot to indicate the node's existence, or a dot with color to indicate a node category or quality.

The information control value may have any desired number of states between its maximal and minimal values, each state corresponding to a level of detail for information displayed in icons. The level of information detail may be a monotonic function of the information control value. For example, in one embodiment, the levels of information detail (LOID) for icon display may vary with respect to an information control value (ICV) as follows:

| ICV | LOID |
|---|---|
| 0 | small circular dot indicating existence of a node |
| 1 | small symbol indicating node category |
| 2 | intermediate size symbol indicating node category and type |
| 3 | large size symbol indicating node category and type with |
| | superimposed IP address |

The table above represents one possible way of defining successive levels of iconic information detail and assigning those levels to states of an information control value. The present invention contemplates a wide variety of ways to define successive levels of information detail and to map them to states of an information control value. The information control value may have any desired number of bits. (The levels of information detail are also referred to herein as rendering plans).

In another embodiment, the levels of information detail (LOID) may vary with respect to an information control value (ICV) as follows:

| ICV | LOID |
|---|---|
| 0 | icon with shape indicating node category |
| 1 | icon with shape indicating node category and color |
| | indicating computational load |
| 2 | icon with shape indicating node category, color indicating |
| | computational load, and with IP address inscribed |
| | underneath the icon |
| 3 | icon with shape indicating node category, color indicating |
| | computational load, and with IP address and install date |
| | inscribed underneath the icon |
| 4 | icon with shape indicating node category, color indicating |
| | computational load, symbols/flags indicating installed |
| | hardware devices and with IP address and install date |
| | inscribed underneath the icon |
| 5 | icon with shape indicating node category, color indicating |
| | computational load, symbols/flags indicating installed |
| | hardware devices, with IP address and install date inscribed |
| | underneath the icon, and with blinking to indicate any error |
| | conditions |

It is noted that the size of the icons do not necessarily vary with respect to information control value. For example, in some situations the icons may be uniformly sized. In other situations, the icons may be sized to reflect the real-world physical size of the corresponding computer node. A wide variety of schemes for assigning sizes to displayed icons are contemplated.

To determine the information control value ICV_{nd} for each node, the software application may implement a function evaluation

ICV_{nd}=f(X_{nd},U),

where X_{nd}=(X₁,X₂, . . . ,X_{N}) represents the position of the node's data structure in the N-dimensional data space, and U is a vector of user-defined parameters. The components X₁, X₂, . . . , X_{N} may be the values of the data fields in the node's data structure. The data fields may be fields such as install date, average computational load, RAM usage, RAM capacity, hard drive usage, hard drive capacity, and so on. The function f may have any of variety of forms. For example, in one embodiment, the function f may be a multi-dimensional Gaussian function. In another embodiment, the function f may represent an executable program. It is noted that the output computed by a program may be more general than the evaluation of a mathematical function.

In one set of embodiments, the function f(X_{nd},U) has the form

f((X₁−V₁)/σ₁, (X₂−V₂)/σ₂, . . . , (X_{N}−V_{N})/σ_{N}),

where the values Vᵢ and σᵢ are the components of the vector U. In particular, the function f may have the multi-dimensional Gaussian form f(Y)=exp(−Y^{T}Y), where Y is a column vector, and the superscript T denotes the transpose operator, and Yᵢ=(Xᵢ-Vᵢ)/σᵢ. Thus, the user may control the width of the Gaussian in each axial direction by adjusting the bandwidth parameters σᵢ and the position of the Gaussian along each of the axial directions in data space by adjusting the parameters Vᵢ. Alternatively, the function f may be a rational function, a piecewise polynomial function, a piecewise constant function (e.g. a step function), an analytic function, etc.

In one set of embodiments, the function f(X_{nd},U) has the form

f(X_{fd},U)=C₁*f₁(X₁,U₁)+C₂*f₂(X₂,U₂)+ . . . +C_{N}*f_{N}(X_{N},U_{N}),

where each function fᵢ operates on a corresponding data field Xᵢ and uses a subset Uᵢ of the parameters in the user parameter vector U. The functions fᵢ may have any of a variety of forms. The weight values C₁, C₂, . . . , C_{N} may be non-negative numbers that add to one. They control how much each evaluation function fᵢ contributes to the information control value ICV. The expression given above describes a linear mixing of the N evaluation function values. More generally, the present invention contemplates linear or nonlinear mixing processes.

In one set of embodiments, a designer of the software application may select a form for each function fᵢ that anticipates the kind of filtering the user is likely use/want for the data field Xᵢ.

In one embodiment, the designer may program the software application to offer the user a choice of functional forms to determine one or more of the functions fᵢ. Thus, the user may determine the type of filtering to be applied to data fields Xᵢ.

In some embodiments, each function fᵢ(Xᵢ,Uᵢ) has the form fᵢ((Xᵢ−Vᵢ)/σᵢ). In one embodiment the function fᵢ is a Gaussian with the form fᵢ(Yᵢ)=exp(−Yᵢ*Yᵢ), where Yᵢ=(Xᵢ−Vᵢ)/σᵢ.

The software application may support a user interface (e.g. a graphical user interface) so that the user may set and dynamically adjust the user parameters. For example, the user interface may provide controls such as dials, sliders, scroll bars, check boxes, numeric input fields and/or other widgets.

In one embodiment, the software application may also provide input controls (e.g. widgets) for selecting a functional form (from a set of supported forms) for one or more of the functions fᵢ.

In some embodiments, the software application may provide input controls so the user may also adjust the weight values Cᵢ.

The user may desire to apply bandpass-style filtering to one or more of the data fields Xᵢ. Thus, one or more of the functions fᵢ may be (or may have the option of being selected as) bandpass filters. For example, a function fᵢ may be a Gaussian, a raised cosine, a rectangular window, a trapezoidal window, a triangular window, a windowed polynomial, etc. The user may determine the pass band by specifying the center X_{c} and width ΔX of the pass band. The function fᵢ may take values near one in the pass band and values that approach zero as the argument Xᵢ moves outside the pass band. Alternatively, the user may specify the lower cutoff X_{lower} and upper cutoff Xᵤₚₚₑᵣ of the pass band.

In some situations, a user may desire to implement a strict bandpass evaluation of the form “X_{lower}<Xᵢ AND Xᵢ<Xᵤₚₚₑᵣ?”, for one or more of the data fields Xᵢ. Thus, one or more of the functions fᵢ may correspond to this type of filtering. The software application may allow the user to supply values X_{center} and ΔX in order to define X_{lower} and Xᵤₚₚₑᵣ through the relations X_{lower}=X_{center}−ΔX/2 and Xᵤₚₚₑᵣ=X_{center}+ΔX/2. (The software application may also support a permissive inequality “<=” as well as strict inequality “<” at either or both of the upper or lower limits. Wherever a permissive or strict inequality is given in an example described herein, it is to be understood, unless stated otherwise, that the other type of inequality may be supported as well.)

The user may desire to apply lowpass-style filtering to one or more of the data fields Xᵢ. Thus, the software application may allow the user to supply a cutoff value X_{CO} for a lowpass function fᵢ. The lowpass function fᵢ takes values near one when the input argument Xᵢ is less than the cutoff value X_{co} and takes values that approach zero as the input argument Xᵢ increases beyond the cutoff value X_{co}. The low pass form may transition from one to zero around the cutoff value in any of a variety of ways (e.g. in a user-selectable way).

In some situations, a user may desire to implement a strict lowpass evaluation of the form “Xᵢ<X_{co}?” Thus, one or more of the functions fᵢ may correspond to this type of filtering.

Similarly, the user may desire to apply highpass-style filtering to one or more of the data fields Xᵢ. Thus, the software application may allow the user to supply a cutoff value X_{co} for a highpass function fᵢ. The highpass function fᵢ takes values near zero when the input argument Xᵢ is less than the cutoff value X_{co} and takes values that approach one as the input argument Xᵢ increases beyond the cutoff value X_{co}. The high pass function may transition from zero to one around the cutoff value in any of a variety of ways (e.g. in a user-selectable way).

In some situations, a user may desire to implement a strict highpass evaluation of the form “Xᵢ>X_{co}?” Thus, one or more of the functions fᵢ may correspond to this type of filtering.

In some circumstances, the user may desire to apply a bandstop filter to one or more of the data fields Xᵢ. Thus, the software application may allow the user to input parameters for a bandstop function fᵢ. The stop band may be defined by a center and width, or alternatively, by an upper and lower cutoff. The bandstop function fᵢ takes values near zero in the stop band and values that approach one as the input argument Xᵢ moves away from the stop band. The bandstop function may transition from zero to one around each of the upper and lower cutoff values in any of a variety of ways. A strict bandstop evaluation may also be supported.

As suggested by some of the examples above, some of the evaluation functions fᵢ may be boolean functions or logical combinations of boolean functions. As used herein, a boolean function is a function that returns a TRUE or FALSE result. The TRUE result may be represented by the value one, and the FALSE result may be represented by the value zero. Examples of boolean functions fᵢ include

fᵢ(Xᵢ,A)=“Xᵢ equal to A?”

fᵢ(Xᵢ,A)=“Xᵢ not equal to A?”

fᵢ(Xᵢ,A)=“Xᵢ greater than A?”

fᵢ(Xᵢ,A)=“Xᵢ less than A?”

fᵢ(Xᵢ,A,B)=“Xᵢ greater than or equal to A AND Xᵢ less than B?”

fᵢ(Xᵢ,U)=“Xᵢ an element of the set U?”

fᵢ(Xᵢ,Xⱼ,A,B)=“Xᵢ greater than A OR Xⱼ less than B?”

fᵢ(Xᵢ,Xⱼ,A,B)=“Xᵢ less than A AND Xⱼ not equal to B?”

fᵢ(Xᵢ,Xⱼ)=“Xᵢ greater than or equal to Xⱼ?”

As suggested by the last few examples some of the evaluation functions may be functions of two or more of data fields.

Furthermore, some of the evaluation functions fᵢ may be string-oriented evaluations. For example, a user may select an evaluation function fᵢ that represents a string test of the form: “Does field Xᵢ contain the user-specified text string Z?”

As another example, a user may select an evaluation function fᵢ that represents a string test of the form: “Does field Xᵢ, interpreted as a text string, equal user-specified text string Z?” The output of such string-oriented evaluation functions may be one or zero.

More generally, an evaluation function fᵢ may be implemented by an arbitrary program (i.e. any desired program) that receives Xᵢ and Uᵢ as inputs. The program may return a floating point value, an integer value, or a Boolean value.

In some embodiments, the user may control the number N of data fields to be used in the information filtering process.

In one set of embodiments, the software application executing on a computer system may be configured to control the display of email information on a computer screen based one or more user-adjustable filters. Email messages associated with a user (or group of users) may be stored in a memory buffer. Each email message may have a variety of associated data fields and flags such as subject line, To and From fields, message content, time sent, time received, carbon copy (CC) list, importance flag, not-yet-opened flag, attachment indicator, message size and so on. The software application may display a representation of each email message. However, the user could easily be overwhelmed with information if each representation included all the data fields and flags of its corresponding email message. Thus, each representation may include an amount of information that depends on the extent to which the corresponding email message satisfies one or more user-adjustable evaluation criteria as represented by one or more corresponding filters.

The software application dynamically filters email messages based on the current state of a set of user-adjustable parameters. The user may adjust the user parameters (e.g. through a graphical user interface), and observe differing populations of email messages come into information fullness.

As described above, the software application may calculate an information control value IVC for each email (and each iteration of the processing loop). The information control value may determine the amount of information (i.e. level of information detail) to be displayed in/on/with/through the message's on-screen representation. An email message having a maximal information control value may be displayed with a fully loaded representation including all available information fields/flags or some selected subset of the available information fields/flags. An email message having a minimal information control value may be displayed with a minimally loaded representation.

The information control value may have any desired number of states between its maximal and minimal values, each state corresponding to a level of detail for information displayed in a message representation. The level of information detail may be a monotonic function of the information control value. For example, in one embodiment, the levels of information detail (LOID) may vary with respect to an information control value (ICV) as follows:

| ICV | LOID |
|---|---|
| 0 | reduced size box indicating presence of message in |
| | memory buffer with outline color indicating whether or not |
| | its has been read |
| 1 | reduced size box indicating presence of message in |
| | memory buffer with outline color indicating whether or not |
| | it has been read, plus abbreviated subject line data |
| 2 | box indicating presence of message in memory buffer with |
| | outline color indicating whether or not it has been read, |
| | plus subject line data, plus FROM field data. |
| 3 | box indicating presence of message in memory buffer with |
| | outline color indicating whether or not it has been read, |
| | plus subject line data, plus FROM field data, plus date sent |
| | field |
| 4 | box indicating presence of message in memory buffer with |
| | outline color indicating whether or not it has been read, |
| | plus subject line data, plus FROM field data, plus data sent |
| | field, plus first K lines of message content (where K is user |
| | selectable parameter). |

The table above represents one possible way of defining successive levels of information detail and assigning those levels to states of an information control value. The present invention contemplates a wide variety of ways to define successive levels of information detail and to map them to states of an information control value. The information control value may have any desired number of states.

The various ways of calculating the information control value described above naturally translate to the email filtering application as well. For example, in one embodiment, the software application may compute the information control value ICV for each email message according to the expression

Icv=C₁*f₁(X₁,U₁)+C₂*f₂(X₂,U₂)+ . . . +C_{N}*f_{N}(X_{N},U_{N}),

where each function fᵢ operates on a corresponding data field Xᵢ of the email message and uses a subset Uᵢ of the parameters in a set U of user-adjustable parameters. The email data fields X₁, X₂, . . . , X_{N} may include fields such as date sent, date received, message content, subject line, From field, To field, CC field, attachments indicator, message size and so on.

Each function fᵢ may have a form (or may be selected from a set of forms) that is (are) appropriate for the corresponding data field Xᵢ. Thus, the function fᵢ may be (or may be selected to be) a bandpass function, a lowpass function, a highpass function, a bandstop function, a boolean function, a string-oriented function, or any of a variety of other functional forms. More generally, the function fᵢ may be realized by a program that implements any desired computational algorithm using the data field Xᵢ and the corresponding user parameter subset Uᵢ.

For example, a user may be interested in seeing more detailed information on email messages that were sent in the range of dates between D₁ and D₂, and sent by senders in a certain domain K₁. Thus, the software application may support a function for filtering based on the date sent field, and another function for filtering based on the domain field of the sender address.

As another example, the user may be interested in seeing more detailed information on email messages sent more than M₀ months ago and containing a certain text string Z_{M} in the message field. Thus, the software application may support a function for filtering based on the date sent field and another function to search for a text string in the message field.

As yet another example, the user may be interested in seeing more detailed information on email messages received more than M₁ months ago, containing a certain text string Z_{S} in its subject line, and having a message size in the range between S₁ and S₂ kilobytes. Thus, the software application may support functions for filtering based on the data received field, for searching for a text string in the subject line, and for filtering on the size field.

The user may adjust the user parameters such as D₁, D₂, K₁, M₀, Z_{M}, M₁, Z_{S}, S₁ and S_{2,} and watch differing sets of email message representations come into prominence (i.e. richness of displayed information detail) as the parameters move.

In another set of embodiments, the software application may be configured to filter real estate information based on one or more user-adjustable filters (or evaluation criteria). A real estate database may store information concerning a collection of properties. A data record for each property may include fields for street address, geographical coordinates, asking price, number of bedrooms, number of baths, square footage, roof materials, flooring, interior/exterior paint color, codes for various conditions and qualities, and so on. To display all the information available for each property would likely overwhelm a human viewer. Thus, the software application may be configured to control the amount of information displayed for each property based on the extent to which the corresponding data record conforms to one or more user-adjustable evaluation criteria as represented by the one or more user-adjustable filters.

The software application dynamically filters data records based on the current state of a set of user-adjustable parameters. Thus, the user may adjust the user parameters (e.g. through a graphical user interface), and observe differing populations of properties come into information fullness.

As described above, the software application may calculate an information control value for each property (and each iteration of the processing loop) using the one or more user-adjustable filters. The information control value may determine the amount of information to be presented (on the display screen or screens) in a display icon (or packet) representing the property. A property having a maximal information control value may be displayed with a fully elaborated display icon. A property having a minimal information control value may be displayed with a minimally elaborated display icon.

The information control value may have any desired number of states between its maximal and minimal values, each state corresponding to a level of information detail for displayed icons. The level of information detail is typically a monotonic function of the information control value. For example, in one embodiment, the levels of information detail (LOID) may vary with respect to an information control value (ICV) as follows:

| ICV | LOID |
|---|---|
| 0 | small dot indicating existence of property, with lowest |
| | priority in stacking order |
| 1 | small symbol with shape indicating asking price, with |
| | second lowest priority in stacking order |
| 2 | intermediate size symbol with shape indicating asking |
| | price, color indicating property age, with appended tag |
| | indicating number of bedrooms and baths, with second |
| | highest priority in stacking order |
| 3 | large symbol with shape indicating asking price, color |
| | indicating property age, with appended tag indicating |
| | number of bedrooms, baths, square footage, construction |
| | materials and garage size, with highest priority in stacking |
| | order |

The icons may overlap each other based on their stacking priority. A higher priority icon may be displayed on top of a lower priority icon. Thus, the higher priority icon would have a higher probability of being visible than the lower priority icon.

The table above represents one possible way of defining successive levels of information detail and assigning those levels to states of an information control value. The present invention contemplates a wide variety of ways to define successive levels of information detail and to map them to states of an information control value. The information control value may have any desired number of states.

The various ways of calculating the information control value described above naturally translate to the real estate application. For example, in one embodiment, the software application may compute the information control value ICV for each property according to the expression

ICV=C₁*f₁(X₁,U₁)+C₂*f₂(X₂,U₂)+ . . . +C_{N}*f_{N}(X_{N},U_{N}),

where each function fᵢ operates on a corresponding data field Xᵢ of the property's data record and uses a subset Uᵢ of the parameters in a set U of user-adjustable parameters. The data fields X₁, X₂, . . . , X_{N} may be fields such as asking price, number of bedrooms, number of baths, square footage, roofing material, interior wall material, geographical coordinates, street address, age of property, etc.

Each function fᵢ may have a form (or may be selected from a set of forms) that is (are) appropriate for the corresponding data field Xᵢ. Thus, the function fᵢ may be (or may be selected to be) a bandpass function, a lowpass function, a highpass function, a bandstop function, a boolean function, a string-oriented function, or any of a variety of other functional forms. More generally, the function fᵢ may be realized by a program that implements any desired computational algorithm using the data field Xᵢ and the corresponding user parameter subset Uᵢ.

For example, a user may be interested in seeing more detailed information on properties that have an asking price in the range between P₁ and P₂, a number of bedrooms between N₁ and N₂, a square footage more than Y, and a distance from his/her place of employment which is less than R_{E} miles. Thus, the software application may support functions for filtering on asking price, number of bedrooms, square footage, and distance from a given location/address.

As another example, a user may be interested in seeing more detailed information on properties built less than T₀ years ago, with wood floors, within R_{C} miles from the city center. Thus, the software application may support functions for filtering on property age, flooring material and distance from a given geographical location.

The user may adjust each of the user parameters such as P₁, P₂, N₁, N₂, Y, R_{E}, T₀ and R_{C}, and note the differing sets of properties that come into prominence (i.e. richness of displayed information) as the parameters move.

The software application may support a user interface (e.g. a graphical user interface) so that the user may set and adjust the user parameters.

In one set of embodiments, the software application executing on the computer system may be configured to implement 3D volume rendering system for an underground reservoir. The software application may control the display of underground reservoir information based on one or more user-adjustable filters. A reservoir simulation may model an underground reservoir as a 3D array of cells containing various substances (e.g. solids, liquids and/or gases). The reservoir simulation may perform computations to predict the time-evolution of properties (e.g. temperature, pressure, density, velocity, flowrate, viscosity) of the substances in the cells. If all the information available to each cell were displayed simultaneously, the sheer volume of data could easily overwhelm a human observer. Thus, in one set of embodiments, the software application may be configured to generate an immersive 3D visualization environment where the properties associated with each cell are represented by visual information such as color, texture, embedded symbols or text, superimposed flow vectors and so on. The amount of information presented for each cell may be controlled by the one or more user-adjustable filters.

The software application may dynamically filter cell data records based on the current state of a set of user-adjustable parameters. The user may adjust the user parameters (e.g. through a graphical user interface), and observe differing populations of the cells come into information fullness.

As described above, the software application may calculate an information control value for each cell using the one or more user-adjustable filters. The information control value may determine the amount of information to be presented (on the display screen or screens) for the cell. A cell having a maximal information control value may be displayed with a full set of information. A cell having a minimal information control value may be displayed with a minimal set of information.

The information control value may have any desired number of states between its maximal and minimal values, each state corresponding to a level of detail for displaying cell information. The level of information detail is typically a monotonic function of the information control value. For example, in one embodiment, the levels of information detail (LOID) may vary with respect to an information control value (ICV) as follows:

| ICV | LOID |
|---|---|
| 0 | cell transparent |
| 1 | cell rendered as fog with thickness (i.e. opacity) indicating |
| | oil pressure |
| 2 | cell rendered as fog with thickness (i.e. opacity) indicating |
| | oil pressure and color indicating cell temperature |
| 3 | cell rendered as fog with thickness (i.e. opacity) indicating |
| | oil pressure and color indicating cell temperature, and with |
| | embedded vector indicating oil flow |

The table above represents one possible way of defining successive levels of information detail and assigning those levels to states of an information control value. The present invention contemplates a wide variety of ways to define successive levels of information detail and to map them to states of an information control value. The information control value may have any desired number of states.

The various ways of calculating the information control value described above naturally translate to the reservoir display application. For example, in one embodiment, the software application may compute the information control value ICV for each cell according to the expression

ICV=C₁*f₁(X₁,U₁)+C₂*f₂(X₂,U₂)+ . . . +C_{N}*f_{N}(X_{N},U_{N}),

where each function fᵢ operates on a corresponding cell data field Xᵢ and uses a subset Uᵢ of the parameters in a set U of user-adjustable parameters.

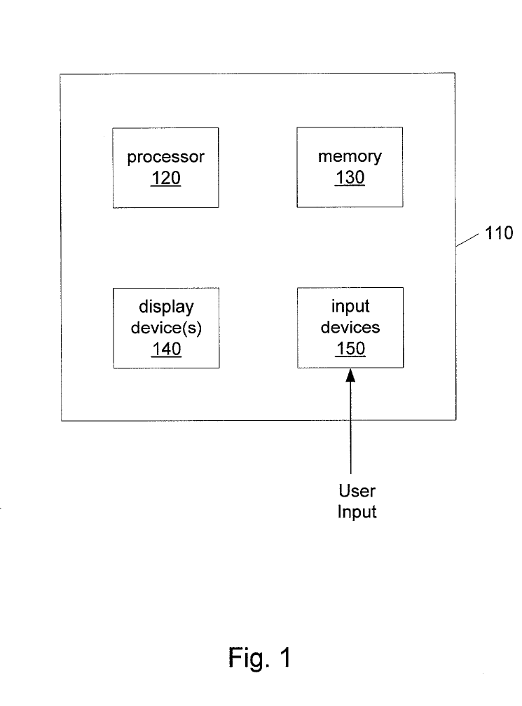

In one set of embodiments, a computer system may be configured to dynamically control the visual display of information based on one or more user-adjustable filters. As illustrated in FIG. 1, the computer system 110 may include a processor 120, a memory 130, a display device 140, and one or more input devices 150.

Memory 130 may include any of various kinds of random access memory (RAM), read only memory (ROM), and/or, mass storage devices. Memory 130 may store program instructions and various data structures. Additionally, memory 130 may store data records associated with a collection of objects. The data records may describe any of a variety of real world objects (such as real estate properties, computers in a network, cells in an underground reservoir, aircraft in an airspace) and/or virtual objects (such as emails in an input buffer, 3D characters in a virtual reality environment). Each data record may correspond to one of the objects, and include a plurality of data fields associated with the corresponding object.

Processor 120 may read the program instructions from memory 130 and execute the program instructions to perform the dynamic information control function as described below.

Input devices 150 may include any of a variety of devices such as a keyboard, mouse, trackball, light pen, digitizing pad, head tracker, one or more eye trackers, and so on. The display device 140 may be realized by any of a variety of devices such as a computer monitor, a projector or a head-mounted display.

Processor 120 receives user input through the one or more input devices specifying parameters for one or more filters. Each filter performs a filtering operation on one or more data fields (of the data records). Each filter may have one or more user-adjustable parameters such as band center, bandwidth, search string, etc.

Processor 120 may apply the one or more filters to each data record (in the collection of data records) to determine one or more corresponding resultant values. The resultant values may be combined in a linear or nonlinear fashion to determine an information control value for the data record. (In one embodiment, the user may select and/or adjust the coefficients of the combining process.)

Processor 120 may display a visual representation of the collection of objects (or the collection of data records) on the display device 140, where the amount of information displayed for each object in the visual representation depends on the information control value of the corresponding data record.

As described above, the filters may have parameters such as bandwidths, band center values, cutoff values, etc. Processor 120 may repeatedly:

(a) receive user updates of the filter parameters from the input devices 150,

(b) recalculate the information control value for each object in the object collection, and

(c) update the visual representation of the objects based on the recalculated information control values.

Thus, the user may control which populations of objects get displayed with information richness. Furthermore, the user may dynamically adjust the filter parameters and observe an evolution of object populations either coming into information prominence or fading into relative information obscurity. This mechanism allows the user to display and search the space of objects in a controlled manner.

The information displayed for an object (or data record) may be symbolic information, textual information, numeric information, or any combination thereof. Furthermore, information may be conveyed through any of various means such as texture, color, opacity-transparency, material luminosity, blinking (and rate of blinking), reflectivity, size, shape, sound, movement and so on. For example, if object A has a larger information control value than object B, object A may be displayed with more symbolic information, more textual information, more numerical information, more opacity (i.e. less translucence), larger size, increased movement (or a different kind of movement), increased sound (or better sound quality), and/or more graphical rendering effort (e.g. higher supersample-to-pixel ratio, higher quality anti-aliasing filters, more primitives) than object B. The amount of information presented for an object may be a monotonic function (e.g. a monotonically increasing function) of its information control value.

A person (e.g. a system designer) may generate M rendering plans for the rendering and display of objects in a visual representation. The rendering plans may be used to render objects (or representations thereof) into pixels. The pixels may be used to update the display device 140. (See the various examples described above). The M rendering plans may be configured as an ordered succession from low information content to high information content. The M rendering plans may be mapped to M states of an information control value. The present invention contemplates a vast multitude of ways of defining successions of rendering plans ordered by information content (or information density or level of information detail).

In one embodiment, a system designer may select an appropriate filter (or filtering operation) for each data field (or group of one or more data fields). The user may enable or disable use of the filter for each data field.

In another embodiment, the system designer may assign a default filter (or default filtering operation) for each data field, and the default filter (or filtering operation) is used unless the user disables the default filter or selects an alternative filter (or filtering operation) for the data field.

In yet other embodiments, some data fields may allow user filter selection and other data fields may not.

Filters may be configured to perform any of a variety of filtering operations such as bandpass filtering, lowpass filtering, highpass filtering, bandstop filtering, Boolean evaluation, string-oriented evaluation, etc. More generally, a filter may have any desired functional form or execute any desired computational algorithm.

The user may specify and dynamically adjust filter parameters (e.g. parameters such as band center, bandwidth, band cutoff values and so on).

Each filter may be interpreted as a user-adjustable criterion for evaluating objects (or data records). Thus, an information control value may indicate an extent to which the corresponding object (or data record) satisfies the one or more evaluation criteria.

In one embodiment, a filter may measure the extent to which a data field resides within a current user-specified range, or the extent to which multiple data fields reside within a current user-specified region of the data space. The user controls the range (or region) through the user-adjustable parameters.

It is noted that one or more of the filters may be configured to perform Boolean tests and/or string-oriented tests as described variously above. In some embodiments, the user may configure a filter as a logical combination of Boolean tests and/or string-oriented tests.

The program instructions may support a graphical user interface through which the user may make filter selections, and/or, set and adjust filter parameters. For example, the user interface may include various on-screen widgets such as sliders, dials, scroll bars, buttons, check boxes and numeric input fields. The user may make selections and/or adjust parameters using the input devices 150.

Each evaluation function (i.e. filter) may operate on one or more data fields of the data records. In some embodiments, the user may select a set of one or more data fields and the evaluation function which is to operate on the set of one or more data fields.

In one embodiment, each evaluation function may return a positive number, e.g., a positive number in the range from zero to one inclusive.

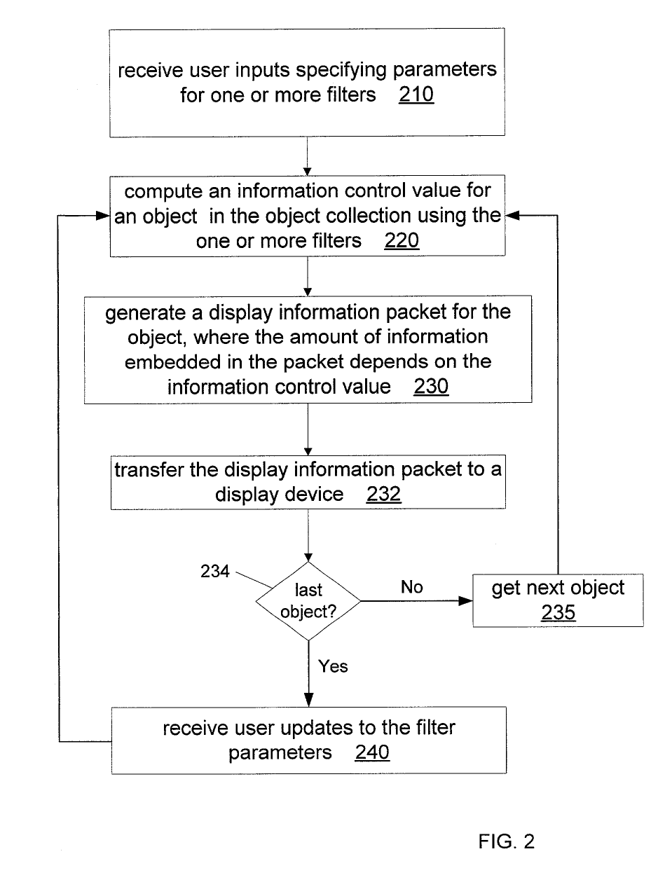

In one set of embodiments, a method for dynamically controlling the visual presentation of object information based on one or more user-adjustable filters may be arranged as illustrated in FIG. 2.

In step 210, a processing unit (e.g. one or more microprocessors, a system of parallel processors, a set of one or more computers in a network, or a dedicated hardware device, etc.) may receive user inputs specifying parameters for one or more user-adjustable filters.

Each object in the object collection has a corresponding data structure (or data record) stored in memory. The data structure may include one or more data fields that describe the object, or, correspond to the object, or, are linked to the object. Each filter (i.e. evaluation function) operates on one or more object data fields, and assigns a number to an object. (That number may represent the extent to which the one or more object data fields conform to a set of user-defined conditions.)

In step 220, the processing unit may compute an information control value for an object in the object collection using the one or more user-adjustable filters. Various methods for computing the information control value using the one or more user-adjustable filters (i.e. evaluation functions) have been described above, and any of those methods or combinations of those methods may be used in step 220. For example, the processing unit may apply the one or more filters to the object data record resulting in a set of output values. The output values may be combined in a linear or nonlinear fashion, e.g., in a user specified fashion, to obtain the information control value.

Any of the user-adjustable filters may be realized by a program. It is noted that a program may implement a computational algorithm that is more general than the evaluation of a mathematical function or a combination of mathematical functions.

In step 230, the processing unit may generate a display information packet for the object, where the amount of information included in the display information packet depends on the information control value.

In step 232, the processing unit may transfer the display information packet to an output device (such as a monitor, a projector, a head-mounted display, a speaker, or any combination thereof). In one embodiment, the processing unit may transfer the display information packet to a rendering agent such as a graphics accelerator. The rendering agent may perform rendering computations for the object based on commands and/or data in the display information packet, and update a pixel frame buffer with the results of the rendering computations. The rendering agent may transfer the pixels from the frame buffer to a digital-to-analog conversion device for conversion to an analog video signal which drives one or more display devices.

In step 234, the processing unit determines if the object just handled is the last object in the object collection. If the object just handled is not the last object in the object collection, the processing unit accesses a next object in the object collection (as indicated in step 235) and returns to step 220.

If the object just handled is the last object in the object collection, the processing unit proceeds to step 240.

In step 240, the processing unit receives user updates to the filter parameters. For example, the user may provide updates to the filter parameters through the input devices 150, e.g., by manipulating one or more input controls (such as slider bars, dials, scroll bars, etc.). After step 240, the processing unit may return to step 220.

By cycling through the inner and outer loops of FIG. 2, the processing unit provides the user with the capacity to search the space of data records, and to dynamically control the manner in which object information is presented on the output device(s).

In some embodiments, the processing unit may cycle through the inner and outer loops with sufficient rapidity to give real-time updates in response to user parameter adjustments. For example, the user may continuously slide a parameter control slider, and watch a smooth evolution of object populations come into information prominence.

In one embodiment, the processing unit may compute the information control value for each object using a single filter function. The single filter function may operate on one or more data fields of the object data record. See the various examples described above.

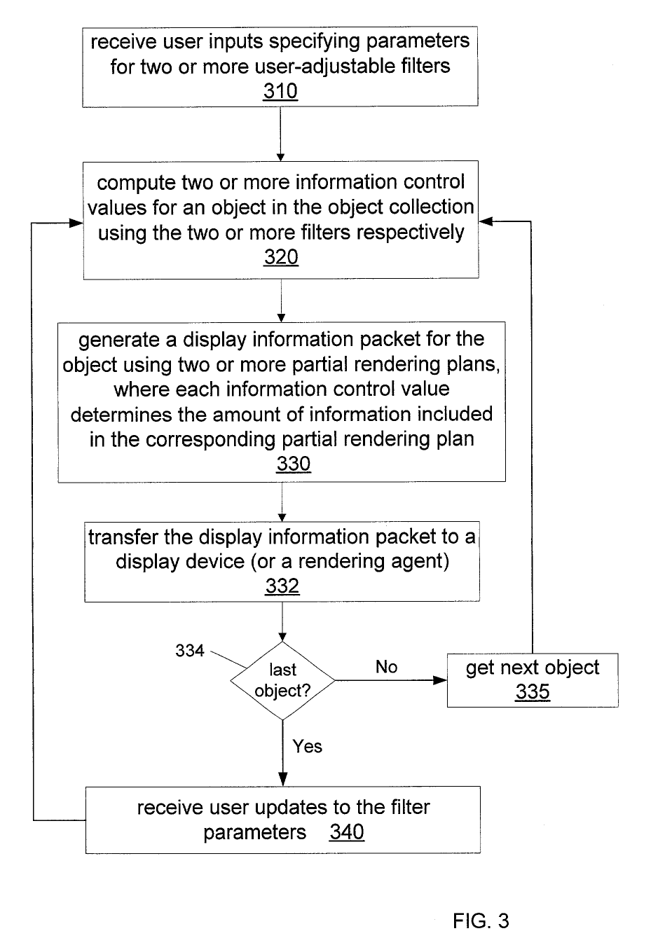

In many of the embodiments described above, the processing unit computes one information control value for each object. In one set of alternative embodiments, the processing unit may compute two or more information control values for each object using two or more corresponding user-adjustable filters (or two or more corresponding sets of user-adjustable filters) as suggested by the flowchart of FIG. 3. Each filter operates on one or more data fields of an object data record. The two or more information control values may be used to construct a display information packet (e.g. a rectangular block of pixels) for the object from two or more corresponding partial rendering plans. Each information control value may determine how much information is included in the corresponding partial rendering plan.

For example, a first information control value may determine whether or not text is to be added to the display information packet (e.g. an onscreen icon) for the corresponding object. A second information control value may determine whether or not to outline the onscreen icon. A third information control value may determine a blink rate for the onscreen icon.

In another example, a first information control value may determine how much and/or what kinds of text to associate with a 3D icon for an object. A second information control value may determine the amount of 3D graphical rendering work is to be performed for the object.

In step 310, a processing unit (e.g. one or more microprocessors, a system of parallel processors, one or more computers in a network, or a dedicated hardware device, etc.) may receive user inputs specifying parameters for two or more user-adjustable filters (or two or more sets of user-adjustable filters). Each filter is configured to operate on one or more data fields.

In step 320, the processing unit may compute two or more information control values for an object in the object collection using the two or more user-adjustable filters respectively (or the two or more sets of user-adjustable filters respectively).

In step 330, the processing unit may construct a display information packet for the object from two or more partial rendering plans, where each information control value determines an amount of information to be included in the corresponding partial rendering plan.

In step 332, the processing unit may transfer the display information packet to an output device (such as a monitor, a projector, a head-mounted display, a speaker, or any combination thereof). In one embodiment, the processing unit may transfer the display information packet to a rendering agent such as a graphics accelerator.

In step 334, the processing unit determines if the object just handled is the last object in the object collection. If the object just handled is not the last object in the object collection, the processing unit may access a next object in the object collection (as indicated in step 335) and returns to step 320.

If the object just handled is the last object in the object collection, the processing unit proceeds to step 340.

In step 340, the processing unit receives user updates to the filter parameters. The user may provide updates to the filter parameters through the input devices 150, e.g., by manipulating one or more input controls (such as slider bars, dials, scroll bars, etc.). After step 340, the processing unit may return to step 320.

In one set of alternative embodiments, the processing unit may incrementally draw various components (or aspects) of an object's display representation onto the display surface. Thus, steps 320-332 may be replaced with the following pseudocode:

(a) operate on a set F_{K} of one or more fields from the object's data record and a corresponding set of the user parameters to determine a control value CV_{K};

(b) conditionally draw a set P_{K} of pixels to the display surface based on the control value CV_{K}, where the pixel set P_{K} corresponds to a K^{th} components of the display representation of the first data record;

iterate (a) and (b) so that index K ranges through a plurality of values, e.g., the range of values 1, 2, . . . , L, where L is an integer greater than or equal to two.

Step (a) may be performed by any of the various methods described above for computing an information control value. The control value CV_{K} may determine whether or not (b) is performed in a current iteration. Alternatively, the control value CV_{K} may select the pixel set P_{K} from a range of possible choices.

The control value CV_{K} may vary as a function of displacement between the set F_{K} of one or more fields of the first data record and the corresponding set of fields of the user parameter vector.

Many of the embodiments described herein have focused on developing an output packet for an object, and then drawing the completed output packet on a display surface. As an alternative, in any of these embodiments, the software application may incrementally draw various aspects of an object's display representation as suggested by the embodiment described above.

In one set of embodiments, the processing unit enables a user to express interest by setting scroll bars or other widgets at various values. Taken together, these values express a point of interest in a parameter space. The user may also set input widgets to express a range of interest around the point of interest. The processing unit refers to the setting of these widgets to calculate how close each datum (to be rendered on the screen) is to the user's point of interest, expressed a fraction of the range of interest. A display object that finds itself within the range of the point of interest may be displayed with a greater level of information detail. Conversely, an object that is far out of range from the point of interest may be rendered very simply with low prominence and/or low information detail, so as to be efficiently rendered, and so as to avoid distracting the user with uninteresting details. To generalize on this methodology, the user may set values to express interest, and the processing unit refers to these values to calculate how much detail is needed when each datum is rendered on the screen. To further generalize, the function used to calculate the level of detail for each datum may be changed by the user as well. In addition, each such function may be parameterized and these parameters may be controlled by the user as well.

While many of the examples described herein have focused on visual output as the primary output mechanism, it is noted that the inventive principles described herein apply to any desired type of output through which information may be conveyed to humans, including, but not limited to, sonic/acoustic output, mechanical output and electromagnetic output.

It is noted that any of the embodiments of the software application described herein may be stored on memory medium such as CD-ROM, magnetic disk, bubble memory, semiconductor RAM and/or ROM.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the headings used herein are for organizational purposes only and are not meant to limit the description provided herein or the claims attached hereto.

What is claimed is:

1. A method comprising:
receiving user inputs defining a user parameter vector;
generating a display representation for each data record in a collection of data records, wherein said generating a display representation for a first data record of said collection comprises:
(a) operating on a set F_{K} of one or more fields of the first data record and a corresponding set of fields of the user parameter vector to determine a control value CV_{K};
(b) conditionally drawing a set P_{K} of pixels to a display surface based on the control value CV_{K}, wherein the set P_{K} of pixels corresponds to a K^{th} component of the display representation of the first data record;
(c) repeating (a) and (b) so that index K ranges through a plurality of values.

2. The method of claim 1, wherein (a) comprises evaluating a function of the set F_{K} of one or more fields of the first data record and the corresponding set of fields of the user parameter vector.

3. The method of claim 1, wherein the control value CV_{K} determines whether or not (b) is performed.

4. The method of claim 1, wherein the control value CV_{K} selects the pixel set P_{K} from a range of possible choices for the K^{th} component of the display representation.

5. The method of claim 1, wherein the control value CV_{K} varies as a function of displacement between the set F_{K} of one or more fields of the first data record and the corresponding set of fields of the user parameter vector.

6. The method of claim 1, wherein (a) comprises executing a program that receives as inputs the set F_{K} of one or more fields of the first data record and the corresponding set of fields of the user parameter vector.

7. The method of claim 1, wherein (a), (b) and (c) are repeated for each data record in said collection of data records.

8. The method of claim 7 further comprising repeatedly performing said receiving and said generating.

9. A system comprising:
a display device;
one or more input devices;
a memory configured to store program instructions;
a processor configured to read and execute the program instructions from the memory, wherein, in response to execution of the program instructions, the processor is further configured to receive user inputs through the one or more input devices defining a user parameter vector, and generate a display representation for each data record in a collection of data records, wherein said generating a display representation for a first data record of said collection comprises:
(a) operating on a set F_{K} of one or more fields of the first data record and a corresponding set of fields of the user parameter vector to determine a control value CV_{K};
(b) conditionally drawing a set P_{K} of pixels to a display surface based on the control value CV_{K}, wherein the set P_{K} of pixels corresponds to a K^{th} component of the display representation of the first data record;
(c) repeatedly performing (a) and (b) so that index K ranges through a plurality of values.

10. The system of claim 9, wherein the processor is further configure to perform (a), (b) and (c) for each data record in said collection of data records.

11. The system of claim 10 wherein the processor is further configured to repeat said receiving and said generating.

12. A method comprising:
(a) receiving user input defining a set of user parameter values;
(b) computing an information control value that measures closeness of one or more fields in a data record of an object with respect to corresponding user parameter values of said set;
(c) drawing pixels corresponding to a component of a display representation of the object on a display surface, wherein the information control value controls said drawing.

13. The method of claim 12, wherein the information control value controls an amount of information represented by the pixels drawn onto the display surface.

14. The method of claim 12, wherein the information control value determines whether said drawing is performed.

15. The method of claim 12, wherein (b) and (c) are performed repeatedly for each component in a collection of components in the object's display representation.

16. The method of claim 15 further comprising repeatedly performing (a), (b) and (c).

17. A system comprising:
a display device;
one or more input devices;
a memory configured to store program instructions;
a processor configured to read the program instructions from the memory, and in response to execution of the program instructions, to:
(a) receive user input through the one or more input devices defining a set of user parameter values;
(b) compute an information control value based on one or more fields in a data record of an object and corresponding user parameter values of said set; and
(c) draw pixels corresponding to a component of the object's display representation on a display surface, wherein the information control value controls said drawing.

18. The system of claim 17, wherein the processor is further configured to perform (b) and (c) for each component in a set of components of the object's display representation.

19. The system of claim 17, wherein the processor is further configured to repeat (a), (b) and (c).

20. The system of claim 17, wherein the information control value varies as a function of displacement of the one or more fields in the object data record with respect to the corresponding user parameter values of said set.

21. A method comprising:
(a) receiving user inputs defining one or more user-adjustable evaluation criteria;
(b) generating an output representation of a collection of objects on an output device, wherein an amount of information generated for each object in the output representation depends on an extent to which the object satisfies the one or more evaluation criteria.

22. The method of claim 21, further comprising:
selecting, for each object, one of M rendering plans based on the extent to which the object satisfies the one or more evaluation criteria, wherein the M rendering plans are ordered according to information content;
rendering each object into pixels based on the corresponding selected rendering plan;
wherein (b) comprises transferring the rendered pixels for each object to the output device.

23. The method of claim 21 further comprising:
(c) receiving user updates to the one or more evaluation criteria; and
repeatedly performing (b) and (c).

24. A method comprising:
(a) applying one or more user-adjustable filters to a data record corresponding to an object in a collection of objects to determine one or more information control values;
(b) generating an output packet for the object, wherein an amount of information in the output packet depends on the one or more information control values; and
(c) displaying a visual representation of the object based on the output packet.

25. The method of claim 24, wherein (a) includes applying each of the one or more filters to the data record to generate a corresponding one of the one or more information control values.

26. The method of claim 24, wherein (a) includes applying a first subset of the one or more filters to the data record to determine a first of the one or more information control values, and applying a second subset of the one or more filters to the data record to determine a second of the one or more information control values.

27. The method of claim 24, wherein each of the one or more filters operates on one or more data fields of the data record.

28. The method of claim 24 further comprising repeating (a), (b) and (c) for each object in the object collection.

29. The method of claim 24, further comprising receiving user updates for parameters of the one or more user-adjustable filters after performing one or more cycles of (a), (b) and (c) on one or more objects in the object collection.

30. The method of claim 24, wherein (b) comprises constructing the output packets from one or more partial rendering plans, wherein an amount of information included in each partial rendering plan is determined by a corresponding one of said one or more information control values.

31. The method of claim 24, wherein the one or more information control values equals one information control value, wherein the method further comprises:
selecting one of M rendering plans for rendering the object into pixels based on said one information control value, wherein the M rendering plans are ordered according to information content;
wherein (c) comprises transferring rendered pixels for the object to a display device.

32. A memory medium configured to store program instructions, wherein the program instructions are executable by a processing device to enact:
(a) applying one or more user-adjustable filters to a data record corresponding to an object in an object collection to determine one or more information control values;
(b) generating an output representation for the object on an output device, wherein an amount of information in the output representation depends on the one or more information control values.

33. A system comprising:
a display device;
one or more input devices;
a memory configured to store program instructions;
a processor configured to read the program instructions from the memory, and in response to the program instructions, to:
(a) apply one or more user-adjustable filters to a data record corresponding to an object in a collection of objects to determine an information control value;
(b) generate an output packet for the object, where an amount of information included in the output packet depends on the information control value;
(c) display a visual representation of the object based on the output packet.

34. The system of claim 33, wherein each of said one or more filters operates on one or more fields of the data record to return a corresponding output value, wherein the processing unit determines the information control value by combining the output values of the one or more filters.

35. The system of claim 33, wherein the one or more filters include one or more programs configured to execute one or more corresponding computational algorithms.

36. The system of claim 33, wherein said one or more filters comprise one or more Boolean evaluation functions.

37. The system of claim 33, wherein said one or more filters comprise one or more string-oriented evaluation functions.

38. The system of claim 33, wherein said one or more filters comprise one or more bandpass functions, lowpass functions, highpass functions or bandstop functions.

39. The system of claim 33, wherein said processor is configured to select one of M rendering plans, ordered according to information content, for generating the output packets for the object, wherein the rendering plan selected for the object is determined by the information control value.

40. The system of claim 33, wherein the processor is configured to repeat (a), (b) and (c) for a number of objects in the object collection.

41. The system of claim 33, wherein the processor is configured to receive user updates for parameters of the one or more user-adjustable filters after performing one or more cycles of (a), (b) and (c) on one or more objects from the object collection.

42. The system of claim 41, wherein the parameters include one or more band center and bandwidth parameters.

43. A system comprising:
a display device;
one or more input devices;
a memory configured to store program instructions;
a processor configured to read the program instructions from the memory, and in response to an execution of the program instructions, to:
(a) apply two or more user-adjustable filters to a data record corresponding to an object in an object collection to determine two or more information control values;
(b) construct an output packet for the object from two or more partial rendering plans, where an amount of information included in each partial rendering plan is determined by the corresponding information control value.
(c) display a visual representation of the object based on the output packet.
